(19) United States
(12) Patent Application Publication
(10) Pub. No.: US 2015/0203052 A1
(43) Pub. Date: Jul. 23, 2015

(54) LIP BALM AND LIPSTICK DISPENSER HOLDERS

(71) Applicant: Michael Wolfsen, Weatherford, TX (US)

(72) Inventor: Michael Wolfsen, Weatherford, TX (US)

(21) Appl. No.: 14/338,900

(22) Filed: Jul. 23, 2014

Related U.S. Application Data
(60) Provisional application No. 61/928,481, filed on Jan. 17, 2014.

(51) Int. Cl. B60R 11/00; A45D 40/06

(52) U.S. Cl. CPC B60R 11/00; A45D 40/06; A45D 2040/0006

(57) ABSTRACT

A lip product dispenser holder includes a receptacle and a clip. The receptacle includes a receptacle wall with a cylindrical shape and a receptacle bottom at one end of the receptacle wall. The receptacle wall and the receptacle bottom form an enclosure open at the other end of the receptacle wall. The enclosure is cylindrical in shape and sized to receive a lip product dispenser. The clip extends from the outer side of the receptacle wall and includes a first prong and a second prong. The first and second prongs are formed to receive and hold a slat of a heating/air conditioning vent of a motorized vehicle between the prongs. A method provides lip product in a lip product dispenser at a lip product temperature within a predetermined range. A lip product maintenance system includes a motorized vehicle, a lip product dispenser, and a lip product dispenser holder.

### REFERENCE TO RELATED APPLICATIONS

This application claims one or more inventions which were disclosed in Provisional Application No. 61/928,481, filed Jan. 17, 2014, entitled “LIP BALM DISPENSER HOLDER”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of containers. More particularly, the invention pertains to holders for lip balm dispensers and lipstick dispensers.

2. Description of Related Art

U.S. Design Pat. No. D528,290, entitled “Lip Balm Holder” and issued Sep. 19, 2006, discloses the ornamental design for a lip balm holder.

U.S. Patent Application Publication No. 2011/0108632, entitled “Air Freshener Vent Clip and Accessory” by Brandenburg et al., published May 12, 2011, discloses an air freshener clip that removably engages with a louver or slat of a vent, such as an automotive heating and air conditioner vent. The clip has a curved, tapered body. When the clip is engaged over the louver or slat, the distal end extends into the vent opening. The air freshener clip has an outer portion formed from fragrance-loaded polymers, and releases fragrance into the air stream that contacts the outer portion on the curved body and is directed out of the vent. An accessory may be removably attached or link to the clip to decorate or adorn the clip.

The above-mentioned patent publications are hereby incorporated by reference herein.

### SUMMARY OF THE INVENTION

A lip product dispenser holder includes a receptacle and a clip. The receptacle includes a receptacle wall with a cylindrical shape and a receptacle bottom at one end of the receptacle wall. The receptacle wall and the receptacle bottom form an enclosure open at the other end of the receptacle wall. The enclosure is cylindrical in shape and sized to receive a lip product dispenser. The clip extends from the outer side of the receptacle wall and includes a first prong and a second prong. The first and second prongs are formed to receive and hold a slat of a heating/air conditioning vent of a motorized vehicle between the prongs. A method provides lip product in a lip product dispenser at a lip product temperature within a predetermined range. A lip product maintenance system includes a motorized vehicle, a lip product dispenser, and a lip product dispenser holder, the system providing a driver with safe and easy access to the lip product while driving.

### BRIEF DESCRIPTION OF THE DRAWINGS

FIG. 1 shows a schematic perspective view of a lip product dispenser holder.

FIG. 2 shows a schematic side view of the lip product dispenser holder of FIG. 1.

FIG. 3 shows a schematic front view of the lip product dispenser holder of FIG. 1.

FIG. 4 shows a schematic top view of the lip product dispenser holder of FIG. 1.

FIG. 5 shows a first schematic perspective view of the lip product dispenser holder of FIG. 1 holding a lip product dispenser in a cap-up orientation.

FIG. 6 shows a second schematic perspective view of the lip product dispenser holder of FIG. 1 holding the lip product dispenser.

FIG. 7 shows a third schematic perspective view of the lip product dispenser holder of FIG. 1 holding the lip product dispenser.

FIG. 8 shows a schematic perspective view of a receptacle of another lip product dispenser holder.

FIG. 9 shows a schematic side view of the receptacle of FIG. 8.

FIG. 10 shows a schematic top view of the receptacle of FIG. 8.

FIG. 11 shows a schematic perspective view of a clip for use with the receptacle of FIG. 8 to form the lip product dispenser holder.

FIG. 12 shows a schematic side view of the clip of FIG. 11 clipped to a slat of a heating/air conditioning vent.

FIG. 13 shows a schematic top view of the clip of FIG. 11.

FIG. 14 shows a schematic bottom view of the clip of FIG. 11.

FIG. 15 shows a schematic perspective view of a receptacle of another lip product dispenser holder.

FIG. 16 shows a schematic side view of the receptacle of FIG. 15.

FIG. 17 shows a schematic top view of the receptacle of FIG. 15.

FIG. 18 shows a schematic perspective view of a clip for use with the receptacle of FIG. 15 to form the lip product dispenser holder.

FIG. 19 shows a schematic top view of the clip of FIG. 18.

FIG. 20 shows a schematic end view of the clip of FIG. 18.

FIG. 21 shows a schematic side view of the clip of FIG. 18.

FIG. 22 shows a schematic perspective view of another lip product dispenser holder.

FIG. 23 shows a schematic side view of the lip product dispenser holder of FIG. 22 clipped to a slat of a heating/air conditioning vent.

FIG. 24 shows a schematic top view of the lip product dispenser holder of FIG. 22.

FIG. 25 shows a schematic bottom view of the lip product dispenser holder of FIG. 22 clipped to a slat of a heating/air conditioning vent.

### DETAILED DESCRIPTION OF THE INVENTION

Cars, trucks, and other motorized vehicles with a heating/air conditioning system have at least one vent to bring heated or air-conditioned air into the passenger space of the vehicle. Generally, the opening of the vent typically has multiple parallel slats that are usually adjustable to direct the heated or air-conditioned air coming into the passenger space. A lip product dispenser holder preferably clips to mount to a slat of the heating/air conditioning vent of the motorized vehicle. The dimensions of the receptacle of a lip balm dispenser holder may be selected so as to hold any lip balm dispenser on the market. The dimensions of the receptacle of a lipstick dispenser holder may be selected so as to hold any lipstick dispenser on the market. The dimensions of the receptacle of a lip balm or lipstick dispenser holder may be selected so as to hold any lip balm or lipstick dispenser on the market. This gives the user extremely easy access to their lip balm or lipstick and is a much safer place to store the lip balm or lipstick than in a purse or pocket or on a surface in the interior of the vehicle.

A lip product dispenser holder, as used herein, is a device designed to attach to the opening of a vent of a heating/air conditioning system of a car, truck, or other motorized vehicle and to hold a lip balm dispenser and/or a lipstick dispenser. In some embodiments, the lip product dispenser holder is a lip balm dispenser holder designed specifically to hold a lip balm dispenser. In other embodiments, the lip product dispenser holder is a lipstick dispenser holder designed specifically to hold a lipstick dispenser. In yet other embodiments, the lip product dispenser holder is a lip balm or lipstick dispenser holder designed so that a user may choose to place either a lip balm dispenser or a lipstick dispenser in the holder.

A lip product, as used herein, is a lip balm or lipstick.

Since the lip product dispenser holder clips onto the vent, the lip balm or lipstick may always be adjusted to within a perfect temperature range for application. In some embodiments, the lip balm or lipstick is adjusted to within the temperature range of about 60 to 90 degrees Fahrenheit. In the summer, it only takes a few minutes to cool the lip balm or lipstick after the air conditioning is turned on in the vehicle Similarly, in the winter, it only takes a few minutes to heat the lip balm or lipstick after the heating is turned on in the vehicle. When it is hot outside, the temperature inside a car can reach as high as 140 degrees Fahrenheit. Since the lip product dispenser holder holds the lip product dispenser upright, the lip balm or lipstick does not melt into the cap or ooze out the lid like it would if it were lying on its side.

The lip product dispenser holder is formed such that the receptacle of the lip product dispenser holder, which receives the lip product dispenser, is maintained in a fixed or predetermined position relative to the clip of the lip product dispenser holder. In some embodiments, the receptacle is rotatable with respect to the clip by a user to allow the holder to clip onto a vent in any position, while keeping the lip product dispenser upright. In some embodiments, the receptacle is rotatable up to at least 45 degrees in at least one direction with respect to the clip. In some embodiments, the receptacle is rotatable up to at least 90 degrees in at least one direction with respect to the clip. In some embodiments, the receptacle is rotatable up to at least 360 degrees in at least one direction with respect to the clip. In some embodiments, the receptacle is infinitely rotatable in either direction with respect to the clip. The mounting of the pin in the set location on the clip keeps the lip product dispenser holder in this position no matter which position the vent is in, including vertical, horizontal, or diagonal at an angle between vertical and horizontal.

A lip balm, as used herein, is any wax-like substance to be applied to the lips of a human mouth. Lip balms serve to prevent or relieve chapped or dry lips or inflammation or infections of the lips. Ingredients in a lip balm may include, but are not limited to, one or more of beeswax, carnauba wax, camphor, lanolin, paraffin, dyes, flavors, fragrances, and ingredients to provide sunscreen protection.

A lip balm dispenser, as used herein, is any dispenser with a cap, a cylindrical container body, and a twist bottom to push the lip balm held within the cylindrical container body toward and out of the top of the container body. Many commercial brands of lip balm dispensers have a diameter of about 0.65 inches (1.65 cm). Some commercial brands of lip balm dispensers have a length of about 2.68 inches (6.8 cm) with the cap on, with the cap having a length of about 0.67 inches (1.7 cm) and the container body and twist bottom having a combined length of about 2.36 inches (6.0 cm). Other commercial brands of lip balm dispensers have a length of about 2.76 inches (7.0 cm) with the cap on, with the cap having a length of about 0.59 inches (1.5 cm) and the container body and twist bottom having a combined length of about 2.44 inches (6.2 cm). A survey of eight different brands of commercially available lip balm dispensers found diameters in the range of about 0.63 to 0.76 inches (1.6 to 1.92 cm), total lengths in the range of 2.64 to 3.48 inches (6.7 to 8.84 cm), cap lengths in the range of about 0.57 to 2.05 inches (1.45 to 5.2 cm) and body/bottom lengths in the range of about 2.34 to 2.88 inches (5.9 to 7.32 cm).

A lip balm dispenser holder is preferably designed for a lip balm dispenser having a diameter in the range of 0.6 to 0.7 inches (1.52 to 1.78 cm) and a total length in the range of 2.5 to 2.9 inches (6.35 to 7.37 cm) with a cap length in the range of 0.5 to 0.75 inches (1.27 to 1.91 cm).

A lipstick, as used herein, is any cosmetic product including one or more of pigments, oils, waxes, and emollients applied to the lips. Lipstick is conventionally used for the purpose of applying a color to the lips but may also apply a texture to the lips or provide protection to the lips.

A lipstick dispenser, as used herein, is any dispenser with a cap, a container body, and a twist bottom to push the lipstick held within the container body toward and out of the top of the container body. Although commercial brands of lipstick are generally of about the same dimensions as lip balms, commercial lipstick dispensers are much less uniform across the industry than lip balm dispensers are. Although many commercial lipstick dispensers are cylindrical in shape, there are also many commercial lipstick dispensers that have a square or nearly square cross section. Many commercial brands of lipstick dispensers have a diameter of about 0.65 inches (1.65 cm). Some commercial square lipstick dispensers have a diagonal measurement in the range of about 0.9 to 1.07 inches (2.3 to 2.7 cm). Some commercial brands of lipstick dispensers have a length of about 2.76 inches (7.0 cm) with the cap on, with the cap having a length of about 0.59 inches (1.5 cm) and the container body and twist bottom having a combined length of about 2.44 inches (6.2 cm).

A lip balm or lipstick dispenser holder is preferably designed for a lip balm dispenser or lipstick dispenser having a diameter or diagonal measurement in the range of 0.6 to 1.07 inches (1.52 to 2.72 cm) and a total length in the range of 2.5 to 2.9 inches (6.35 to 7.37 cm) with a cap length in the range of 0.5 to 0.75 inches (1.27 to 1.91 cm).

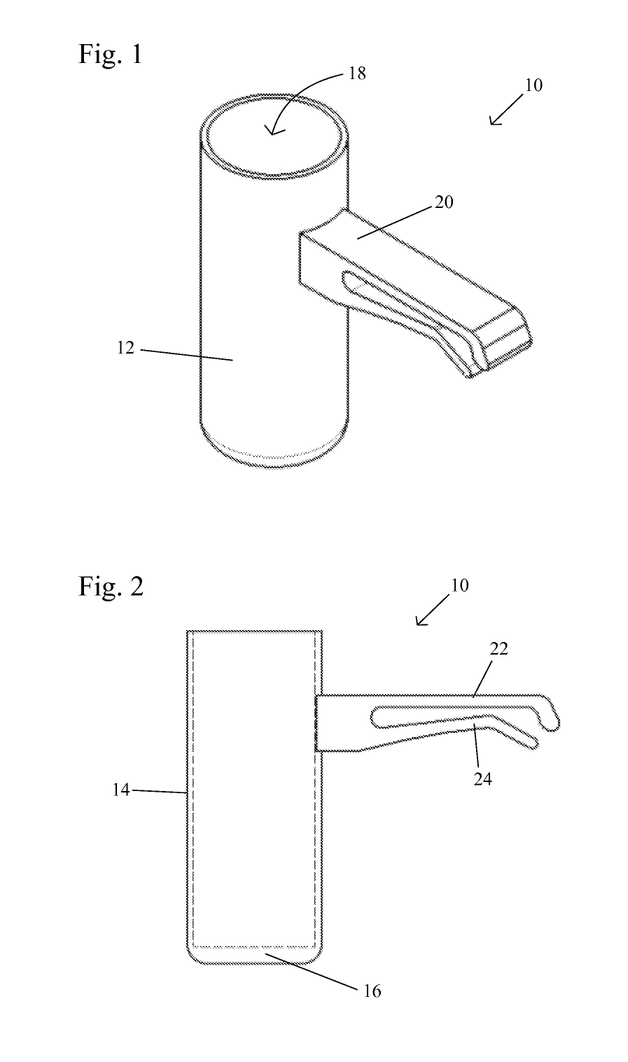

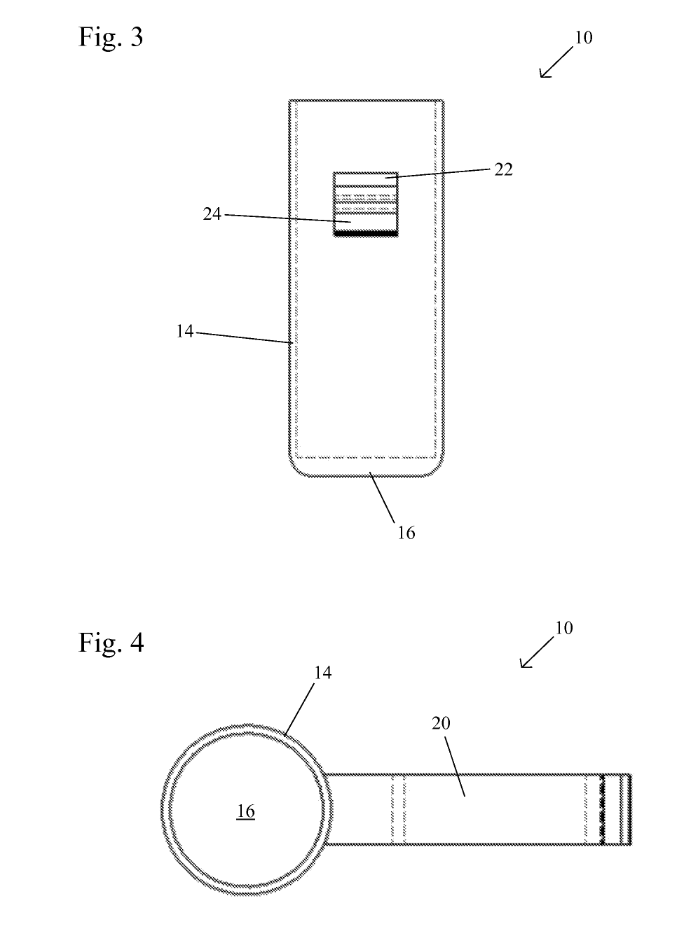

FIG. 1 through FIG. 4 show a lip product dispenser holder 10 including a receptacle 12 with a receptacle wall 14 and a receptacle bottom 16, forming an enclosure 18 having a substantially cylindrical shape that is open on the top and closed on the bottom, and a clip 20 affixed to and extending from the outer side of the receptacle wall 14. In some embodiments, the lip product dispenser holder 10 is formed as a single piece made of the same material. In some embodiments, the inner diameter of the receptacle wall 14 is in the range of about 0.5 inch to 1.0 inch (1.27 to 2.54 cm), preferably in the range of about 0.6 to about 0.85 inches (1.52 to 2.16 cm) and more preferably about 0.77 inches (1.96 cm). In other embodiments, the inner diameter of the receptacle wall 14 is in the range of about 0.5 inch to 1.2 inches (1.27 to 3.05 cm), preferably in the range of about 0.6 to about 1.08 inches (1.52 to 2.74 cm) and more preferably about 1.08 inches (2.74 cm).

The clip 20 includes a top prong 22 and a bottom prong 24. The top prong 22 extends straight out and curls downward at the distal end. The bottom prong 24 angles up slightly toward the top prong 22 to create a minimum gap before also angling downward at its distal end. At least one of the two prongs 22, 24 is slightly flexible so that one of the slats on the heating/air conditioning vent is insertable between the two prongs 22, 24 past the minimum gap and is held in place as the prongs 22, 24 relax to their unbent positions. The lip product dispenser holder 10 in FIG. 1 through FIG. 4 was designed for use with a horizontal slat, but alternatively, the clip may be formed with the prongs rotated by 90 degrees with respect to the design of FIG. 1 through FIG. 4 in order to accommodate a vertical slat.

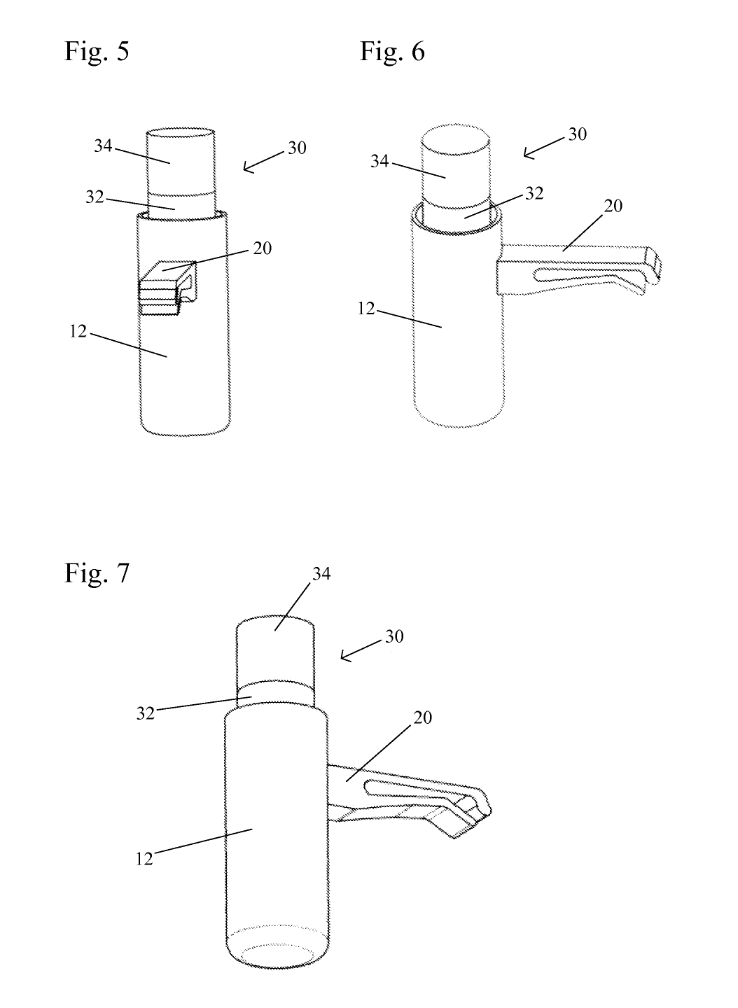

As shown in FIG. 5 through FIG. 7, the height of the receptacle wall 14 is preferably less than the height of the cylindrical container body 32 of the lip product dispenser 30 but high enough to contain a lip product dispenser 30 without the lip product dispenser 30 falling out of the lip product dispenser holder 10 during normal operation of a vehicle having a heating/air conditioning vent to which the lip product dispenser holder 10 is clipped. The height of the receptacle wall 14 is preferably in the range of about 1 inch and 3 inches, more preferably in the range of about 1.5 inches and 2.5 inches. In some embodiments, the height of the receptacle wall 14 is about 2 inches. More preferably, the cap 34 of the lip product dispenser 30 is completely above the open end of the receptacle 12 when the lip product dispenser 30 is closed and seated in the lip product dispenser holder 10 with the cap 34 at the top, as shown in FIG. 5 through FIG. 7. The receptacle wall 14 is preferably thin. In some embodiments, the thickness of the receptacle wall is about 0.04 inches (1 mm) The clip 20 is preferably attached to one of the lower slats of the heating/air conditioning vent so that the cap 34 is held in the airstream exiting from the heating/air conditioning vent.

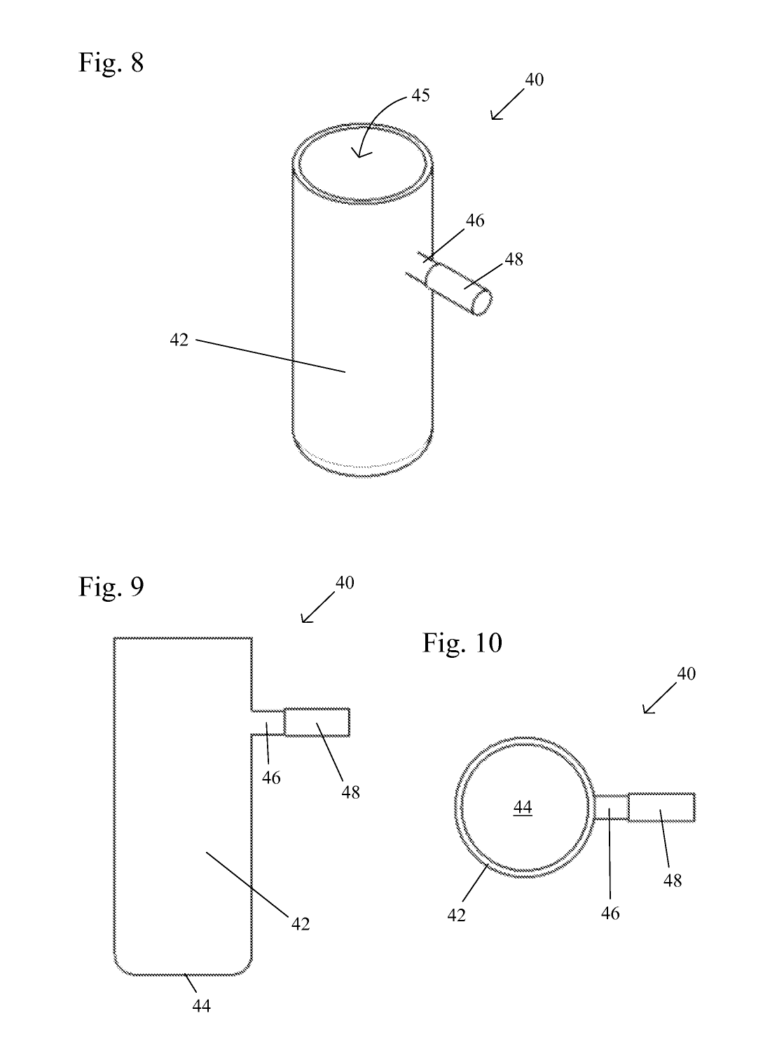

FIG. 8 through FIG. 10 show a receptacle 40 of a lip product dispenser holder with a receptacle wall 42 and a receptacle bottom 44, forming an enclosure 45 having a substantially cylindrical shape that is open on the top and closed on the bottom, and a peg 46 extending from the outer side of the receptacle wall 42 with a pin 48 on the distal end of the peg 46. In some embodiments, the receptacle 40 is formed as a single piece, with the receptacle wall 42, receptacle bottom 44, peg 46, and pin 48 all being made of the same material.

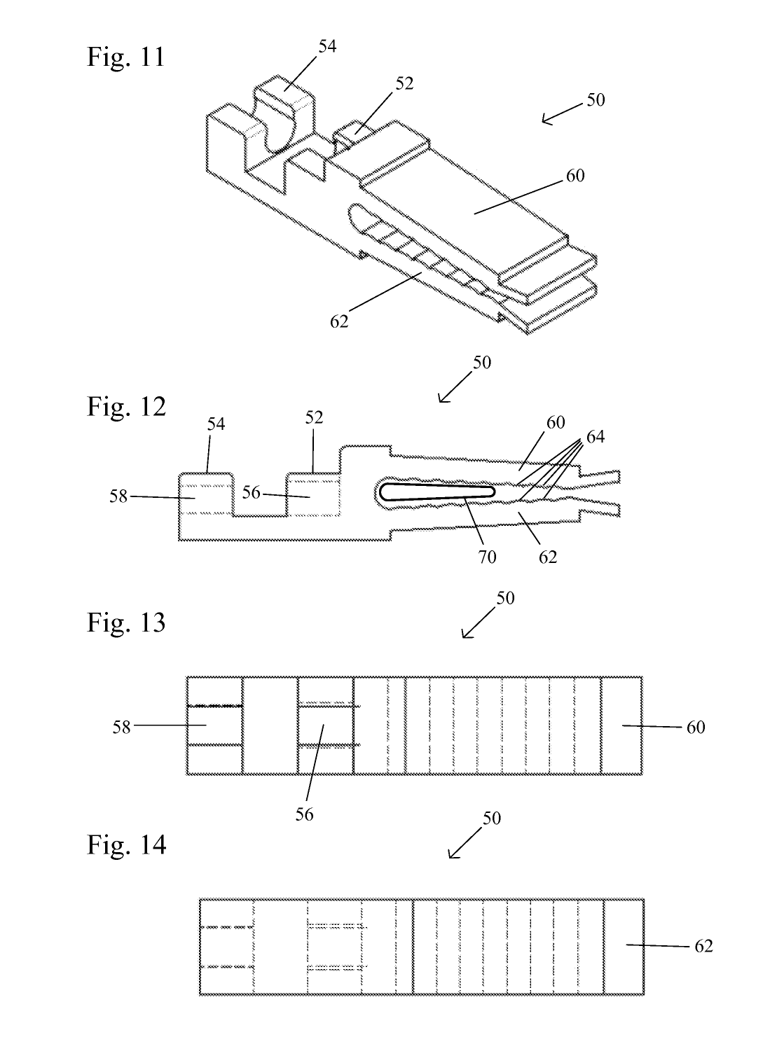

FIG. 11 through FIG. 14 show a clip 50 with a first end including a first mount 52 to receive and retain at least a portion of the pin 48 of the receptacle 40 and a second mount 54 to receive and retain at least a portion of the peg 46. In some embodiments, the clip 50 is formed as a single piece made of the same material. The mounts 52, 54 are open on the top to allow insertion of the pin 48 and peg 46, respectively, and are sized to receive the pin 48 and peg 46 in any angular orientation and to allow the pin 48 and peg 46 to be rotated by a user when mounted. The pin 48 preferably has a diameter greater than the diameter of the peg 46, which prevents the pin 48 and peg 46 from sliding out of the mounts 52, 54 when the receptacle 40 is mounted to the clip 50. In some embodiments, the pin 48 and the opening 56 in the first mount 52 each have a diameter of about 0.17 inches, the peg 46 and the opening 58 in the second mount 54 each have a diameter of about 0.15 inches, the peg 46 and pin 48 together are about 0.6 inches long, and the gaps above the openings 56, 58 are each about 0.14 inches wide.

The second end of the clip 50 includes a top prong 60 and a bottom prong 62. The prongs 60, 62 are substantially symmetric, angling slightly toward each other from their proximal ends toward their distal ends before angling apart again at their distal ends, preferably with teeth 64 on the surfaces of the prongs 60, 62 facing each other to aid in retaining one of the slats 70 of the heating/air conditioning vent.

The receptacle 40 and the clip 50 together form a lip product dispenser holder capable of clipping to one of the slats 70 of the heating/air conditioning vent with the receptacle 40 being at any angular orientation with respect to the slat 70. This allows the lip product dispenser to be held in a substantially upright position in the lip product dispenser holder regardless of the particular orientation of the slat 70. The clip 50 is preferably attached to one of the lower slats or to the lower end of one of the slats of the heating/air conditioning vent.

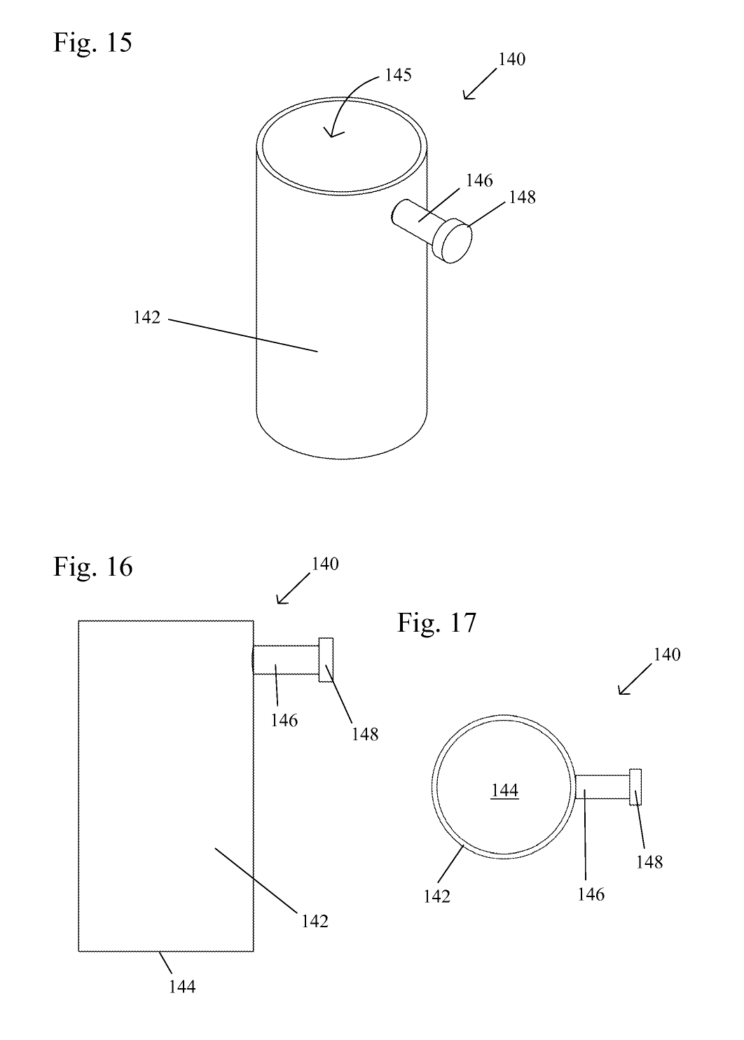

FIG. 15 through FIG. 17 show a receptacle 140 of a lip product dispenser holder with a receptacle wall 142 and a receptacle bottom 144, forming an enclosure 145 having a substantially cylindrical shape that is open on the top and closed on the bottom, and a peg 146 extending from the outer side of the receptacle wall 142 with a pin 148 on the distal end of the peg 146. In some embodiments, the receptacle 140 is formed as a single piece, with the receptacle wall 142, receptacle bottom 144, peg 146, and pin 148 all being made of the same material. In other embodiments, however, the peg 146 is attached to the receptacle wall 142 and may be made of the same material or a different material as the receptacle wall 142.

In some embodiments, the outer diameter of the receptacle wall 142 is about 1.12 inches and the inner diameter is about 1.04 inches. In some embodiments, the height of the receptacle 140 is about 2.12 inches. In some embodiments, the peg 146 has a diameter of about 0.182 inches. In some embodiments, the pin 148 has a diameter of about 0.28 inches. In some embodiments, the peg 146 is about 0.42 inches long and the pin 148 is about 0.1 inches long. In some embodiments, the central axis of the pin 148 and peg 146 is about 0.25 inches from the top of the receptacle wall 142.

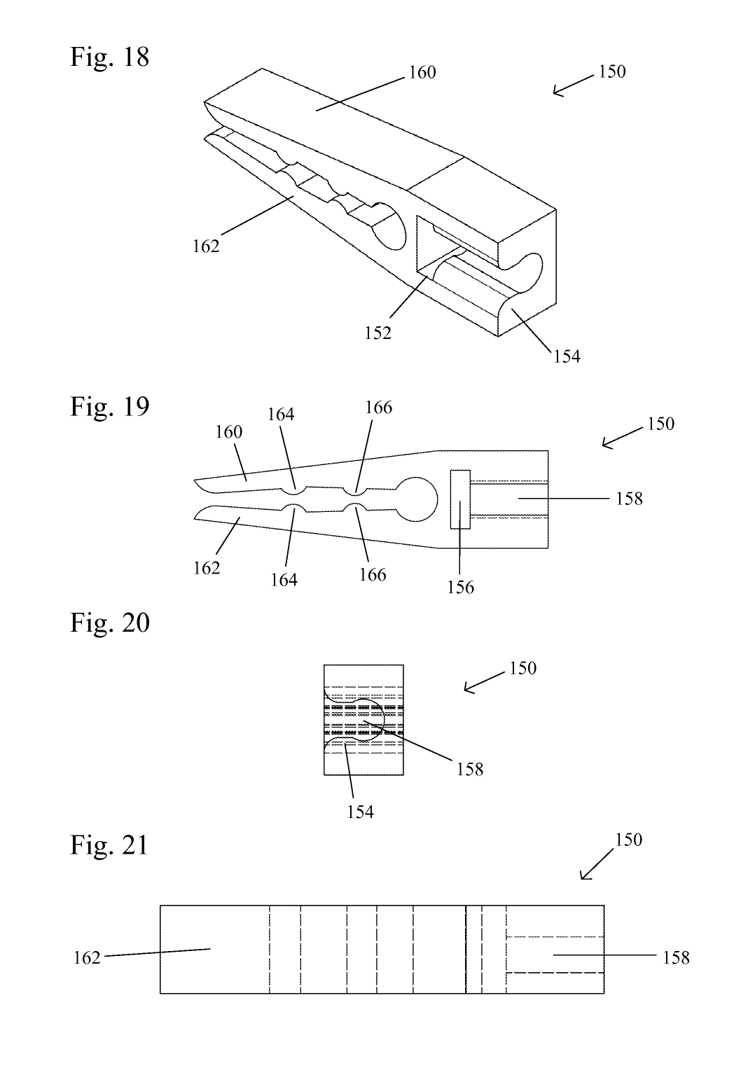

FIG. 18 through FIG. 21 show a clip 150 with a first end including a first mount 152 to receive at least a portion of the pin 148 of the receptacle 140 and a second mount 154 to receive at least a portion of the peg 146. At least one of the two mounts 152, 154 is also designed to retain the pin 148 or peg 146, respectively. In some embodiments, the clip 150 is formed as a single piece made of the same material. The mounts 152, 154 are open on the top to allow insertion of the pin 148 and peg 146, respectively, and are sized to receive the pin 148 and peg 146 in any angular orientation and to allow the pin 148 and peg 146 to rotate when mounted. The pin 148 preferably has a diameter greater than the diameter of the peg 146, which prevents the pin 148 and peg 146 from sliding out of the mounts 152, 154 through the opening 158 when the receptacle 140 is mounted to the clip 150.

The second end of the clip 150 includes a top prong 160 and a bottom prong 162. The prongs 160, 162 are substantially symmetric, angling slightly toward each other from their proximal ends toward their distal ends, with teeth 164, 166 on the surfaces of the prongs 160, 162 facing each other to aid in retaining one of the slats of the heating/air conditioning vent. Although rounded teeth 164, 166 are shown in FIG. 18 and FIG. 19, any tooth shape that aids in retaining one of the slats of the heating/air conditioning vent may be used within the spirit of the present invention.

In some embodiments, the clip 150 is designed to fit commercial vent slats of any thickness. The large hole in the middle is for flexion. This allows the two prongs to flex up enough while gripping the vent. The first pair of teeth 164 provides a first grip, and the second pair of teeth 166 provides a second grip. In some embodiments, the first grip is designed to grip a thicker vent having a thickness in the range of 0.12 to 0.17 inches (0.3 to 0.43 cm) without substantially deforming the clip 150. The second grip is designed to hold a thinner vent having a thickness in the range of 0.09 to 0.11 inches (0.23 to 0.28 cm). The slot and groove are designed so the pin snaps in place and does not fall out. The through slot is for the larger end of the pin and the smaller groove is for the body of the pin. This also gives the clip freedom to swivel 360 degrees with ease. The pin is of a size that gives it an interference fit while snapping into the clip. The hole on the clip is sized to allow freedom of rotation.

In some embodiments, the clip 150 is about 1.81 inches long. In some embodiments, the mount end of the clip 150 is about 0.5 inches wide, about 0.36 inches tall, and about 0.565 inches long. In some embodiments, the opening 156 in the first mount 152 has a diameter of about 0.3 inches. In some embodiments, the opening 158 in the second mount 154 has a diameter of about 0.19 inches. In some embodiments, the gap above the opening 158 is about 0.16 inches wide.

The receptacle 140 and the clip 150 together form a lip product dispenser holder capable of clipping to one of the slats of the heating/air conditioning vent with the receptacle 140 being at any angular orientation with respect to the slat. This allows the lip product dispenser to be held in a substantially upright position in the lip product dispenser holder regardless of the particular orientation of the slat. The clip 150 is preferably attached to one of the lower slats or to the lower end of one of the slats of the heating/air conditioning vent.

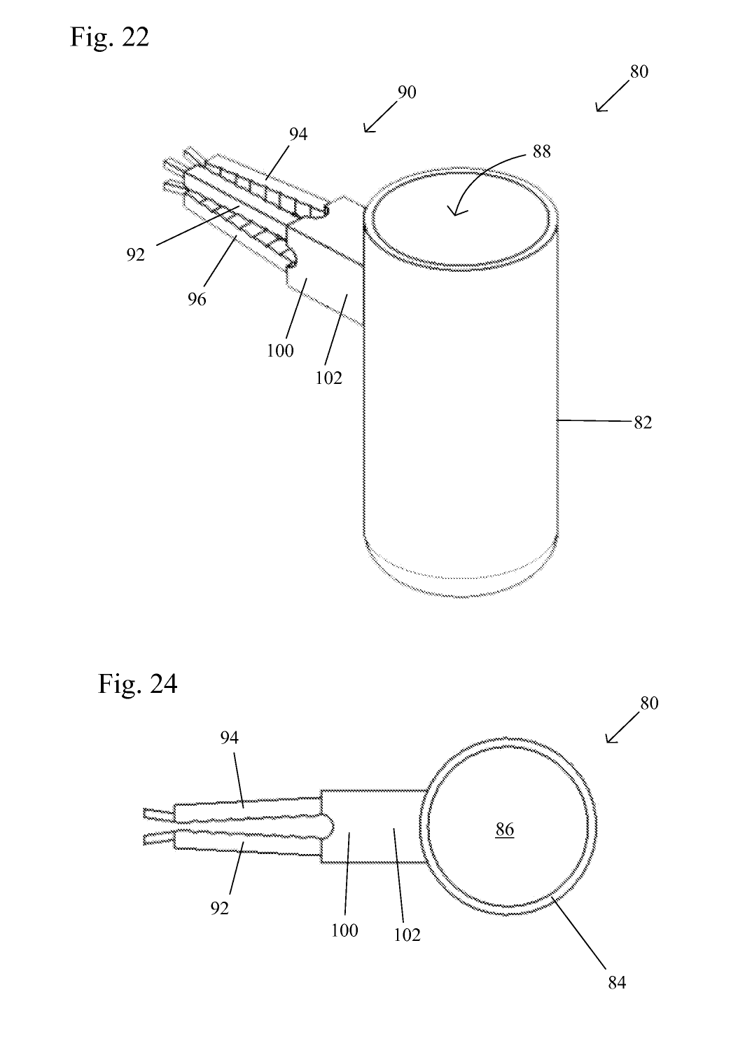

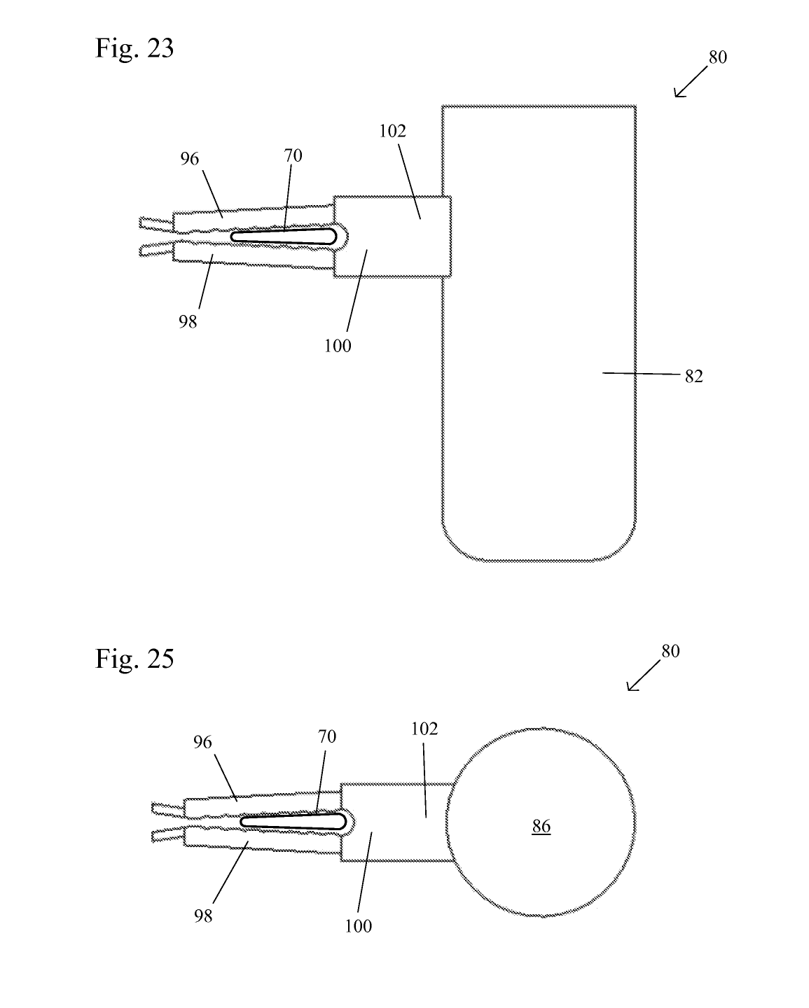

FIG. 22 through FIG. 25 show a lip product dispenser holder 80 including a receptacle 82 with a receptacle wall 84 and a receptacle bottom 86, forming an enclosure 88 having a substantially cylindrical shape that is open on the top and closed on the bottom, and a clip 90 affixed to and extending from the outer side of the receptacle wall 84. In some embodiments, the lip product dispenser holder 80 is formed as a single piece made of the same material. The clip 90 includes four prongs 92, 94, 96, 98 in a substantially square arrangement to work as pairs with neighboring prongs. The prongs 92, 94, 96, 98 are similar in design to those of FIG. 11 through FIG. 14, preferably including teeth. One of the slats 70 of the heating/air conditioning vent can be inserted into the clip 90 in either of the two orientations shown in FIG. 23 and FIG. 25. In some embodiments, the space between the first prong 92 and the second prong 94 and the space between the third prong 96 and the fourth prong 98 is wider than the space between the first prong 92 and the third prong 96 and the space between the second prong 94 and the fourth prong 98 to accommodate a wider range of slat 70 thicknesses, similar to the teeth 164, 166 of the clip 150 shown in FIG. 18 through FIG. 21.

Although a lip product dispenser holder may be made of one or more of a number of different materials within the spirit of the present invention, the lip product dispenser holder is preferably made of plastic and more preferably Bisphenol A (BPA)-free acrylonitrile butadiene styrene (ABS).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A lip product dispenser holder comprising:
a receptacle comprising:
a receptacle wall having a cylindrical shape; and
a receptacle bottom at a first end of the receptacle wall;
wherein the receptacle wall and the receptacle bottom form an enclosure open at a second end of the receptacle wall opposite the first end;
wherein the enclosure is cylindrical in shape and sized to receive a lip product dispenser; and
a clip extending from an outer side of the receptacle wall and comprising:
a first prong; and
a second prong;
wherein the first prong and the second prong are formed to receive and hold a slat of a heating/air conditioning vent of a motorized vehicle in a first space between the first prong and the second prong.

2. The lip product dispenser holder of claim 1, wherein the enclosure has a diameter in a range of about 0.77 to about 1.08 inches.

3. The lip product dispenser holder of claim 1, wherein the clip is rotatable with respect to the receptacle.

4. The lip product dispenser holder of claim 1, wherein the lip product dispenser is a lip balm dispenser.

5. The lip product dispenser holder of claim 1, wherein the lip product dispenser is a lipstick dispenser.

6. The lip product dispenser holder of claim 1, further comprising teeth formed on opposing surfaces of the first prong and the second prong.

7. The lip product dispenser holder of claim 1, wherein the receptacle further comprises a peg extending from the outer side of the receptacle wall having a peg diameter and a pin extending from a distal end of the peg having a pin diameter different from the peg diameter, and the clip further comprises a first mount having a first opening sized to receive the pin and a second mount having a second opening sized to receive the peg such that the pin and peg are mountable in the first mount and the second mount, respectively, at any angular orientation.

8. The lip product dispenser holder of claim 1, wherein the clip further comprises a third prong and a fourth prong, the first prong, the second prong, the third prong and the fourth prong being formed to receive and hold the slat of a heating/air conditioning vent of a motorized vehicle in a first clipped position in the first space formed between the first prong and the second prong and a second space formed between the third prong and the fourth prong or in a second clipped position in a third space formed between the first prong and the third prong and a fourth space formed between the second prong and the fourth prong.

9. The lip product dispenser holder of claim 8, wherein the first clipped position is orthogonal to the second clipped position.

10. The lip product dispenser holder of claim 8, wherein the first space formed between the first prong and the second prong and the second space formed between the third prong and the fourth prong are wider than the third space formed between the first prong and the third prong and the fourth space formed between the second prong and the fourth prong.

11. The lip product dispenser holder of claim 8, further comprising teeth formed on opposing surfaces of the first prong and the second prong, opposing surfaces of the third prong and the fourth prong, opposing surfaces of the first prong and the third prong, and opposing surfaces of the second prong and the fourth prong.

12. The lip product dispenser holder of claim 1, wherein the clip reversibly attaches the lip product dispenser holder to the slat.

13. The lip product dispenser holder of claim 1, wherein the lip product dispenser is made of BPA-free acrylonitrile butadiene styrene.

14. A method of providing a lip product in a lip product dispenser at a lip product temperature within a predetermined range, the method comprising:
a) placing the lip product dispenser in a cap-up orientation in an enclosure of a receptacle of a lip product dispenser holder comprising:
the receptacle comprising:
a receptacle wall having a cylindrical shape; and
a receptacle bottom at a first end of the receptacle wall;
wherein the receptacle wall and the receptacle bottom form an enclosure open at a second end of the receptacle wall opposite the first end;
wherein the enclosure is cylindrical in shape and sized to receive the lip product dispenser; and
a clip extending from an outer side of the receptacle wall and comprising:
a first prong; and
a second prong;
wherein the first prong and the second prong are formed to receive and hold a slat of a heating/air conditioning vent of a motorized vehicle in a clip space formed between the first prong and the second prong;
b) mounting the lip product dispenser holder to the slat of the heating/air conditioning vent of the motorized vehicle by inserting the slat into the clip space formed between the first prong and the second prong; and
c) running a heating/air conditioning system of the motorized vehicle at a setting to provide air through the heating/air conditioning vent to bring the lip product to the lip product temperature within the predetermined range.

15. The method of claim 14, wherein step c) comprises running a heating system of the motorized vehicle at a setting to provide heated air through the heating/air conditioning vent to raise a temperature of the lip product to be within the predetermined range.

16. The method of claim 14, wherein step c) comprises running an air conditioning system of the motorized vehicle at a setting to provide cooled air through the heating/air conditioning vent to lower a temperature of the lip product to be within the predetermined range.

17. The method of claim 14, wherein the predetermined range is 60 to 90 degrees Fahrenheit.

18. The method of claim 14, wherein the lip product dispenser is a lip balm dispenser.

19. The method of claim 14, wherein the lip product dispenser is a lipstick dispenser.

20. A lip product maintenance system comprising:
a motorized vehicle comprising a heating/air conditioning system comprising a heating/air conditioning vent having at least one slat to direct air exiting the heating/air conditioning vent;
a lip product dispenser comprising a container body, a cap received on an open end of the container body, and a dispenser bottom attached to a closed end of the container body opposite the open end and twistable to push lip product held within the container body toward and out of the open end of the container body; and
a lip product dispenser holder comprising:
a receptacle comprising:
a receptacle wall having a cylindrical shape; and
a receptacle bottom at a first end of the receptacle wall;
wherein the receptacle wall and the receptacle bottom form an enclosure open at a second end of the receptacle wall opposite the first end;
wherein the lip product dispenser is received in the enclosure; and
a clip extending from an outer side of the receptacle wall and comprising:
a first prong; and
a second prong;
wherein the slat of the heating/air conditioning vent is received and held in a clip space formed between the first prong and the second prong.
